(19) United States
(12) Patent Application Publication
(10) Pub. No.: US 2010/0105354 A1
(43) Pub. Date: Apr. 29, 2010

(54) MOBILE PHONE AND METHOD FOR MANAGING COMMUNICATION FEES

(75) Inventor: WEN-JENG HUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/499,102

(22) Filed: Jul. 8, 2009

(30) Foreign Application Priority Data
Oct. 24, 2008 (CN) 200810305179.6

(51) Int. Cl. H04M 11/00; H04M 1/00

(52) U.S. Cl. 455/406; 455/566

(57) ABSTRACT

A mobile phone and method for managing communication fees of the mobile phone sets a plurality of charge standards of different telecommunication providers and an allowable communication fee of the mobile phone during a preset time period. Calculation of a total communication fee of a current call is according to a corresponding charge standard of a telecommunication provider of the mobile phone and a previous total communication fee of the mobile phone. The current call may be terminated when the total communication fee reaches the allowable communication fee.

### BACKGROUND

1. Technical Field

Embodiments of the present disclosure relate to communication services of mobile phones, and more particularly to a mobile phone and method for managing communication fees of the mobile phone.

2. Description of Related Art

It has become common to use mobile communication devices, such as mobile phones or personal data assistants (PDA), to engage in wireless communication. However, large communication fees are often incurred when a user of the mobile phone uses mobile communication services.

In order to restrict the large communication fees, a communication charge system has been offered. The communication charge system can report communication times at the end of every communication. However, the communication charge system has a disadvantage that it cannot control total communication fees of the mobile phone.

Therefore, there is an improved system and method for managing communication fees to overcome the above-mentioned disadvantages.

### BRIEF DESCRIPTION OF THE DRAWINGS

FIG. 1 is a schematic diagram of one embodiment of a mobile phone for managing communication fees.

FIG. 2 is a flowchart of one embodiment of a method for managing communication fees of the mobile phone of FIG. 1.

FIG. 3 is a schematic diagram of one embodiment of user interfaces by using the mobile phone of FIG. 1.

### DETAILED DESCRIPTION

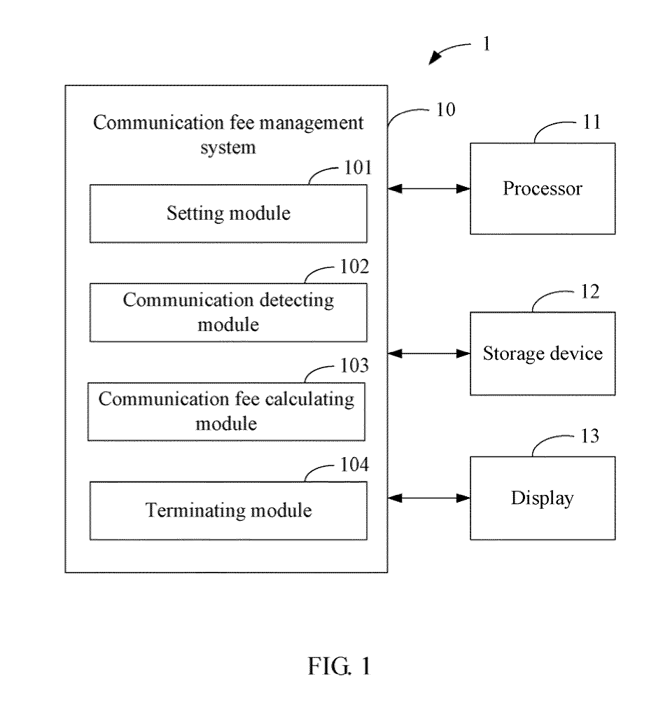

FIG. 1 is a schematic diagram of one embodiment of a mobile phone 1 including a communication fee management system 10. The communication fee management system 10 is used to manage communication fees when a user of the mobile phone 1 uses mobile communication services. The mobile phone 1 may include at least one processor 11 that executes computerized codes of the communication fee management system 10, and may further include a storage device 12 and a display 13. In one embodiment, the communication fee management system 10 is included in the storage device 12 or a computer readable medium of the mobile phone 1.

The storage device 12 stores a plurality of charge standards of different telecommunication providers, and an allowable communication fee of the mobile phone 1 during a preset time period. The telecommunication providers may be Sprint, T-Mobile, and AT&T, for example. Each of the mobile telecommunication providers can provide different communication services for the user of the mobile phone 1 when the user accepts a charge standard of the mobile telecommunication provider. The preset time period may be a week, a month, or two months, for example. In one embodiment, the storage device 12 may be a smart media card, a secure digital card, a compact flash card, a multi media card, or extreme digital card, and so on.

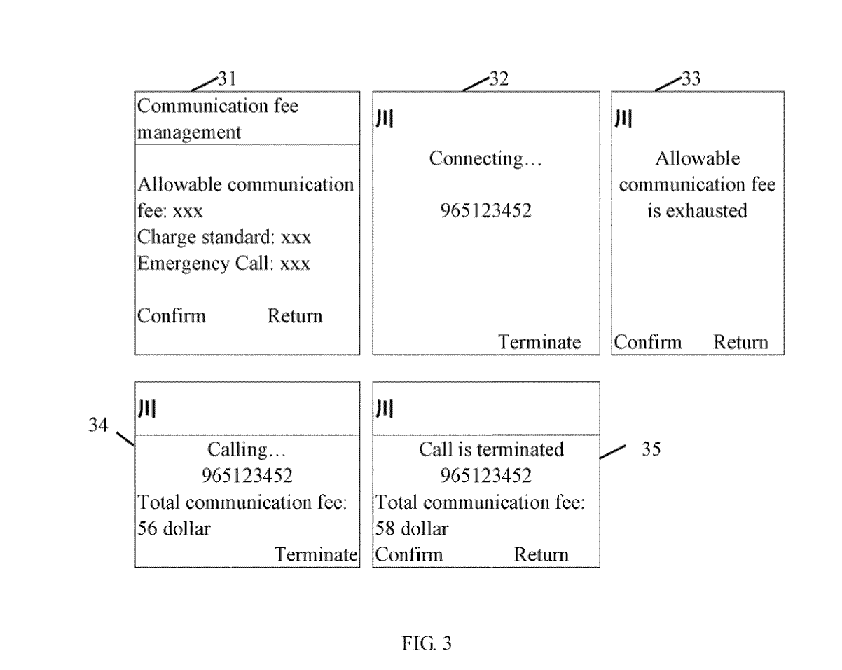

The display 13 is operable to display a plurality of user interfaces provided by the communication fee management system 10. Referring to FIG. 3, the user interfaces may include a setting interface 31, a calling interface 32, a prompting interface 33, and a communication fee reporting interface 34 when calling, and a communication fee reporting interface when terminating.

The communication fee management system 10 may include a setting module 101, a communication detecting module 102, a communication fee calculating module 103, and a terminating module 104. Each of the function modules 101-104 may comprise one or more computerized operations that can be executed by the at least one processor 11 of the mobile phone 1.

The setting module 101 is operable to set the plurality of charge standards of different telecommunication providers, preset a time period, and set the allowable communication fee of the mobile phone 1 during the preset time period. The setting module 101 is also operable to store the charge standards and the allowable communication fee in the storage device 12. For example, the user may set a charge rate as 6 cents per second according to the charge standard of Sprint by using the setting module 101. Each of the charge standards can be reset when the charge standards of a corresponding telecommunication provider changes. Further, the setting module 101 is operable to set emergency calls (e.g., dialing 911) as free calls. All the settings may be manipulated in the setting interface 31.

The communication detecting module 102 is operable to detect a current call made by the user of the mobile phone 1, and display the calling interface 32 on the display 13. The communication detecting module 102 is operable to determine if a previous total communication fee has reached the allowable communication fee (spending limit) during the preset time period. If the previous total communication fee reaches the allowable communication fee, the communication detecting module 102 displays the prompting interface 33 to prompt the user that the allowable communication fee is exhausted and places the mobile phone 1 in a communication restriction mode. In the communication restricted mode only emergency calls (e.g., 911) can be made. Otherwise, if the previous total communication fee does not reach the allowable communication fee, the communication detecting module 102 allows calls to be made.

The communication fee calculating module 103 is operable to calculate a total communication fee according to the previous total communication fee and a corresponding charge standard of a telecommunication provider of the mobile phone 1, and display the total communication fee on the communication fee reporting interface 34 of the display 13 of the mobile phone 1. The total communication fee is calculated according to: the total communication fee=the previous total communication fee+(the charge standard*a current communication time).

The terminating module 104 is operable to determine if the total communication fee reaches the allowable communication fee during the preset time period. The terminating module 104 is further operable to terminate the current call if the total communication fee reaches the allowable communication fee or when a terminating instruction is received. The terminating instruction is sent by the user of the mobile phone 1 when the user presses a button of the mobile phone 1 to terminate the current call.

Further, the calculating module 103 is operable to calculate the total communication fee according to all previous communication times and charge standards recorded in the storage device 12. The calculating module 103 displays the total communication fee on the communication fee reporting interface 35 if the total communication fee reaches the allowable communication fee or when the mobile phone receives the terminating instruction.

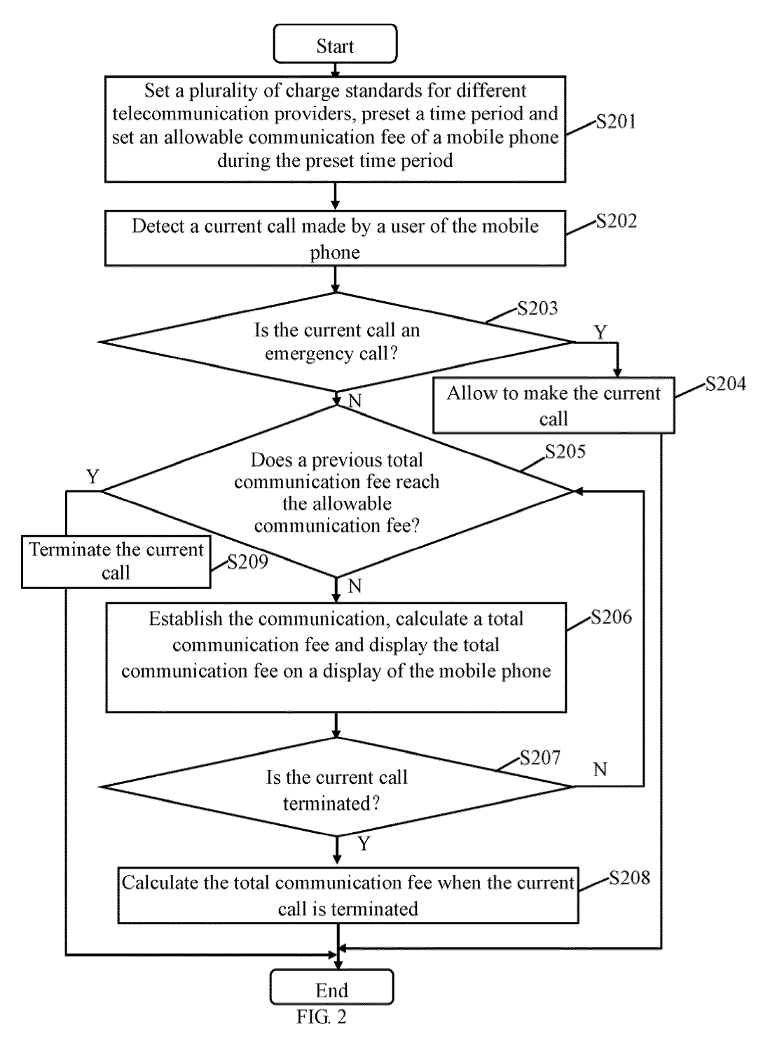

FIG. 2 is a flowchart of one embodiment of a method for managing a communication fee of the mobile phone 1 by using the system 10 of FIG. 1 as described above. Depending on the embodiment, additional blocks may be added, others removed, and the ordering of the blocks may be changed.

In block S201, the setting module 101 sets the plurality of charge standards of different telecommunication providers, presets a time period and the allowable communication fee during the preset time period, and stores the charge standards and the allowable communication fee into the storage device 12. As mentioned above, the user may set a charge rate as 6 cents per second according to the charge standard of Sprint by using the setting module 101. The allowable communication fee may be set $120. The preset time period may be a week, a month, or two months, for example.

In block S202, the communication detecting module 102 detects a current call made by the user of the mobile phone 1, and generates a calling interface 32 on the display 13.

In block S203, the communication detecting module 102 determines whether the current call is the emergency call according to a destination number of the current call. If the current call is the emergency call, in step S204, the mobile phone 1 allows to make the current call.

Otherwise, in step S205, the communication detecting module 102 determines if the previous total communication fee plus a current communication fee, if the mobile phone 1 is in a call, reaches the allowable communication fee. If the previous total communication fee reaches the allowable communication fee, in step S209, the communication detecting module 102 displays the prompting interface 33 to prompt the user that the allowable communication fee is exhausted and places the mobile phone 1 in the communication restriction mode, and terminates the current call if is the call.

If the previous total communication fee does not reach the allowable communication fee, in block S206, the communication fee calculating module 103 establishes the communication, calculates a total communication fee and displays the total communication fee on the communication fee reporting interface 34 of the display 13 of the mobile phone 1. The total communication fee is calculated according to method disclosed above.

In block S207, the terminating module 104 determines if the current call is terminated. If the current call is not terminated, the procedure goes back to block S205. Otherwise, the procedure goes to block S208.

In block S208, the terminating module 104 terminates the current call. The communication fee calculating module 103 calculates the total communication fee according to all previous communication times and charge standard recorded in the storage device 12 when the current call is terminated. The terminating module 104 further displays the total communication fee on the communication fee reporting interface 35 when terminating.

All of the processes described above may be embodied in, and fully automated via, functional code modules executed by one or more general purpose processors of electronic devices. The functional code modules may be stored in any type of readable medium or other storage devices. Some or all of the methods may alternatively be embodied in specialized the electronic devices.

Although certain inventive embodiments of the present disclosure have been specifically described, the present disclosure is not to be construed as being limited thereto. Various changes or modifications may be made to the present disclosure without departing from the scope and spirit of the present disclosure. For example, the above-described mobile phone 1 and the communication fee management system 10 may be applied to other national or international telephone communication providers.

What is claimed is:

1. A mobile phone for managing communication fees, the mobile phone comprising:
a storage device;
a display operable to display a plurality of user interfaces; and
at least one processor operable to execute a communication fee management system, the communication fee management system comprising:
a setting module operable to set a plurality of charge standards of different telecommunication providers, preset a time period, set an allowable communication fee of the mobile phone during the preset time period, and store the charge standards, the preset time period and the allowable communication fee into the storage device;
a communication detecting module operable to detect a current call made by a user of the mobile phone;
a communication fee calculating module operable to:
calculate a total communication fee of the current call according to a corresponding charge standard of a telecommunication provider of the mobile phone, and a previous total communication fee of the mobile phone; and
record the total communication fee into the storage device, and display the total communication fee on the display; and
a terminating module operable to determine if the total communication fee reaches the allowable communication fee during the preset time period, and terminate the current call when the total communication fee reaches the allowable communication fee of the mobile phone.

2. The mobile phone according to claim 1, wherein the total communication fee is calculated according to: the total communication fee=the previous total communication fee+(the charge standard*a current communication time).

3. The mobile phone according to claim 1, wherein each of the mobile telecommunication providers provides a communication service to the user of the mobile phone when the charge standard setting module sets a charge standard of the mobile telecommunication provider.

4. The mobile phone according to claim 1, wherein each of the charge standards is reset when the charge standard of a corresponding telecommunication provider changes.

5. The mobile phone according to claim 1, wherein the storage device is selected from the group consisting of a smart media card, a secure digital card, a compact flash card, a multi media card, and an extreme digital card.

6. A method for managing communication fees of a mobile phone, the method comprising:
setting a plurality of charge standards of different telecommunication providers, preset a time period and an allowable communication fee of the mobile phone during the preset time period;
detecting a current call made by a user of the mobile phone;
calculating a total communication fee of the current call according to a corresponding charge standard of a telecommunication provider of the mobile phone and a previous total communication fee of the mobile phone;
recording the total communication fee into a storage device of the mobile phone;
displaying the total communication fee on a display of the mobile phone; and
terminating the current call when the total communication fee reaches the allowable communication fee of the mobile phone.

7. The method according to claim 6, wherein the total communication fee is calculated according to:
the total communication fee=the previous total communication fee+(the charge standard*a current communication time).

8. The method according to claim 6, wherein each of the charge standards is reset when the charge standard of a corresponding telecommunication provider changes.

9. The method according to claim 6, wherein the storage device is selected from the group consisting of a smart media card, a secure digital card, a compact flash card, a multi media card, and an extreme digital card.

10. A readable medium having stored thereon instructions that, when executed by a processor of a mobile phone, cause the mobile phone to perform a method for managing communication fees, the method comprising:
setting a plurality of charge standards of different telecommunication providers, preset a time period and an allowable communication fee of the mobile phone during the preset time period;
detecting a current call made by a user of the mobile phone;
calculating a total communication fee of the current call according to a corresponding charge standard of a telecommunication provider of the mobile phone and a previous total communication fee of the mobile phone;
recording the total communication fee into a storage device of the mobile phone;
displaying the total communication fee on a display of the mobile phone; and
terminating the current call when the total communication fee reaches the allowable communication fee of the mobile phone.

11. The medium according to claim 10, wherein the total communication fee is calculated according to:
the total communication fee=the previous total communication fee+(the charge standard*a current communication time).

12. The medium according to claim 10, wherein each of the charge standards is reset when the charge standard of a corresponding telecommunication provider changes.

13. The medium according to claim 10, wherein the storage device is selected from the group consisting of a smart media card, a secure digital card, a compact flash card, a multi media card, and an extreme digital card.
